(19) United States
(12) Patent Application Publication
(10) Pub. No.: US 2021/0302279 A1
(43) Pub. Date: Sep. 30, 2021

(54) SWAB MATERIAL

(71) Applicant: SHIMADZU CORPORATION, Kyoto-shi, Kyoto (JP)

(72) Inventors: Takeshi IHARADA, Kyoto-shi (JP); Kiyuki NOTO, Kyoto-shi (JP)

(73) Assignee: SHIMADZU CORPORATION, Kyoto-shi, Kyoto (JP)

(21) Appl. No.: 16/330,455

(22) PCT Filed: Sep. 6, 2016
(86) PCT No.: PCT/JP2016/076215

§ 371 Date: Mar. 5, 2019

(51) Int. Cl. G01N 1/04; G01N 31/12

(52) U.S. Cl. CPC G01N 1/04; G01N 2001/028; G01N 31/12

(57) ABSTRACT

A swab material 5 is configured from a knitted body 50 in which fibers 51 formed from a heat-resistant inorganic material are knitted. A surface of an object is wiped off by the swab material 5 to collect a substance, and the swab material 5 is inserted together with the collected substance into a combustion tube provided in a total carbon measurement device. Because the swab material 5 includes the knitted body 50, tip ends of the fibers 51 constituting the knitted body 50 hardly protrude from the surface thereof, and the fibers 51 are not prone to coming apart from each other. Consequently, the surface of the object is hardly damaged when the substance is collected from the surface of the object, and high durability is obtained.

### TECHNICAL FIELD

The present invention relates to a swab material that is inserted into a combustion tube provided in a total carbon measurement device.

### BACKGROUND ART

For example, as a method for performing cleanliness evaluation (cleaning validation) of a pharmaceutical facility or the like, there are known a method of using a high-performance liquid chromatography (HPLC) and a method of using a total organic carbon measurement device (TOC meter). The TOC meter includes an inorganic carbon measurement device and a total carbon measurement device, whereby the total organic carbon (TOC) contained in a sample can be measured based on inorganic carbon (IC) measured by the inorganic carbon measurement device and total carbon (TC) measured by the total carbon measurement device.

The method of using HPLC is suitable for detecting a specific substance; however, the method of using a TOC meter is suitable for widely detecting an unexpected substance or an accidental contamination. Also, the method of using a TOC meter has an advantage of being suitable for screening because the measurement time is short.

Methods of collecting a substance from a surface of an object after cleaning can be roughly classified into a rinse method and a swab method (wiping method). In the swab method, a certain area of the surface of the object such as a pharmaceutical facility is wiped off with use of the swab material, whereby the substance (adherent residue) adhering to the surface of the object is physically collected. In measuring the substance collected by the swab method with use of the TOC meter, it is possible to select a method of inserting the swab material together with the collected substance into a combustion tube of a total carbon measurement device or a method of extracting the collected substance from the swab material into pure water and injecting the resultant into a combustion tube of a total carbon measurement device.

In the method of extracting the substance, which has been collected to the swab material, into pure water, the surface of the object is wiped off with use of a swab material formed, for example, from cloth or cotton, and the substance is extracted by immersing this swab material into pure water. Further, the pure water in which the substance has been extracted is injected into a combustion tube and heated at a temperature of, for example, 900° C., so as to evaporate the pure water and burn the substance. Carbon dioxide that is generated during this process is detected with use of a detector, whereby the substance that has been collected as a substance can be detected based on the detection results.

On the other hand, in the method of inserting the collected substance together with the swab material into a combustion tube, the surface of the object is wiped off with use of a swab material formed, for example, from a non-combustible fiber or the like, and this swab material is inserted into a combustion tube (for example, see Patent Document 1 below). In the combustion tube, the collected substance burns, whereas the non-combustible swab material does not burn. Accordingly, only the carbon dioxide generated by combustion of the substance is detected by the detector, and the substance collected as the substance can be detected based on the detection results. This method has an advantage in that even a substance insoluble in water can be detected.

### PRIOR ART DOCUMENT

### Patent Document

Patent Document 1: Japanese Utility Model Publication No. 3142280

### SUMMARY OF THE INVENTION

### Problems to be Solved by the Invention

As described in the above Patent Document 1, a quartz glass cloth or the like, for example, is used as a conventional swab material. Specifically, a swab material is used in which numerous fibers made of quartz glass are shaped as a non-woven cloth having a web form. In such a swab material, the tip ends of the fibers constituting the non-woven cloth are liable to protrude from the surface, raising a fear that the surface of the object may be damaged by the tip ends of the fibers. Further, the fibers constituting the non-woven cloth are prone to coming apart from each other, and the durability is low, thereby raising a problem in that the surroundings are prone to contamination by the loosened fibers.

The present invention has been made in view of the aforementioned circumstances, and an object thereof is to provide a swab material having a high durability in which a surface of an object is hardly damaged in collecting a substance from the surface of the object.

### Means for Solving the Problems

A swab material according to the present invention is a swab material used for wiping off a surface of an object to collect a substance existing thereon, the swab material being inserted together with the collected substance into a combustion tube provided in a total carbon measurement device. The swab material includes a knitted body in which fibers formed from a heat-resistant inorganic material are knitted.

According to such a construction, the swab material is made of a knitted body, so that the tip ends of the fibers constituting the knitted body hardly protrude from the surface, and the fibers are not prone to coming apart from each other. Consequently, the surface of the object is hardly damaged when the substance is collected from the surface of the object, and high durability is obtained.

Also, the fibers constituting the knitted body are made of a heat-resistant inorganic material, so that the swab material can be thermally treated at a high temperature to remove the impurities that inherently adhere to the swab material before wiping off the surface of the object, and carbon dioxide is not generated from the swab material itself during the burning in the combustion tube. Accordingly, only the carbon dioxide generated from the substance that has been collected from the surface of the object can be detected, so that the detection accuracy can be improved.

It is preferable that the knitted body has a melting point of 450° C. or higher.

With such a configuration, the swab material is not melted even when the swab material is thermally treated before the surface of the object is wiped off, provided that the temperature is at least lower than 450° C. Accordingly, thermal treatments on the knitted body can be effectively carried out, and the impurities that inherently adhere to the swab material can be effectively removed.

It is preferable that of the knitted body has an end surface folded back thereon.

With such a configuration, the knitted body has an end surface folded back thereon, so that the tip ends of the fibers constituting the knitted body hardly protrude from the ends of the knitted body. Consequently, the surface of the object is hardly damaged in collecting the substance from the surface of the object.

### Effects of the Invention

According to the present invention, the tip ends of the fibers constituting the knitted body hardly protrude from the surface, so that the surface of the object is hardly damaged in collecting the substance from the surface of the object. Also, according to the present invention, the fibers are not prone to coming apart from each other, and high durability is obtained, thereby making it possible to avoid a situation in which the fibers themselves are scattered around in an environment in which an experiment is carried out.

### BRIEF DESCRIPTION OF THE DRAWINGS

FIG. 1 is a view showing a configuration example of a total organic carbon measurement device in which analysis is performed with use of a swab material according to one embodiment of the present invention.

FIG. 2 is a schematic enlarged view showing a part of the swab material.

FIG. 3A is a schematic perspective view showing a flow in forming the swab material from a knitted body.

FIG. 3B is a schematic perspective view showing a flow in forming the swab material from a knitted body.

FIG. 3C is a schematic perspective view showing a flow in forming the swab material from a knitted body.

### MODE FOR CARRYING OUT THE INVENTION

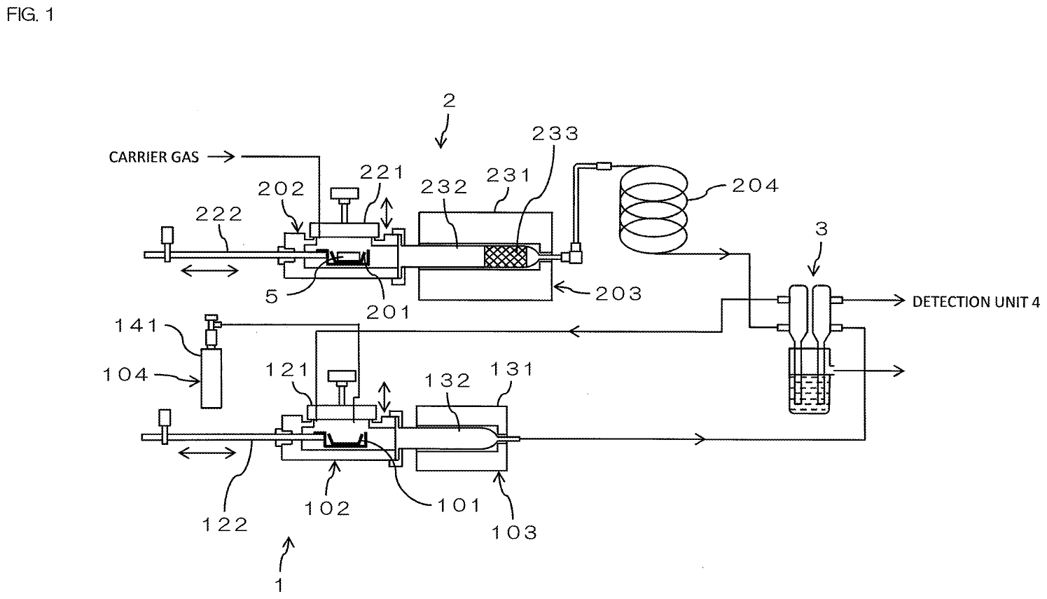

FIG. 1 is a view showing a configuration example of a total organic carbon measurement device in which analysis is performed with use of a swab material according to one embodiment of the present invention. This total organic carbon measurement device includes an inorganic carbon measurement device 1 and a total carbon measurement device 2. The total organic carbon (TOC) contained in a sample can be measured based on the inorganic carbon (IC) measured by the inorganic carbon measurement device 1 and the total carbon (TC) measured by the total carbon measurement device 2. Here, TOC can be calculated by using a relationship formula of TOC=TC−IC.

The inorganic carbon measurement device 1 includes, for example, a sample placement unit 102 for placing a sample boat 101 on which a sample is mounted, a heating reaction unit 103 for heating the sample on the sample boat 101 that has been inserted from the sample placement unit 102, and an acid solution adding unit 104 for adding an acid solution to the sample on the sample boat 101. The sample boat 101 can be formed, for example, from ceramics; however, the present invention is not limited to this, so that the sample boat 101 can be formed from various other kinds of heat-resistant materials.

The sample placement unit 102 is provided with a cover 121 that can be opened and closed. In a state in which the cover 121 is opened, the sample boat 101 can be placed in the sample placement unit 102. The sample boat 101 placed in the sample placement unit 102 can be inserted into the heating reaction unit 103 by moving a moving rod 122 disposed in the sample placement unit 102.

The heating reaction unit 103 includes, for example, a tubular electric furnace 131 disposed in a lateral direction and a reaction tube 132 disposed in the electric furnace 131 and made of hard glass. The sample boat 101 that is moved by the moving rod 122 from within the sample placement unit 102 is inserted into the reaction tube 132 in the heating reaction unit 103. The temperature of the electric furnace 131 is set to be, for example, 200° C., and the sample on the sample boat 101 that has been inserted into the reaction tube 132 can be heated.

The acid solution adding unit 104 includes a syringe pump 141 that can automatically eject a set amount of the acid solution. The ejection outlet of the syringe pump 141 is in communication with an inside of the sample placement unit 102. The acid solution can be added (dropped) to the sample on the sample boat 101 by driving the syringe pump 141 in a state in which the sample boat 101 is placed at a prescribed position within the sample placement unit 102 and the cover 121 is closed.

After the acid solution is added to the sample in the aforementioned manner, the sample boat 101 is inserted into the reaction tube 132 in the heating reaction unit 103. The sample on the sample boat 101 that has been inserted into the reaction tube 132 reacts with the acid solution, whereby carbon dioxide is generated in an amount corresponding to the amount of inorganic carbon contained in the sample. Phosphoric acid or the like, which is one example of a non-volatile acid, can be used as the acid solution; however, the present invention is not limited to this.

The total carbon measurement device 2 includes, for example, a sample placement unit 202 for placing a sample boat 201 on which a sample is mounted, and a combustion reaction unit 203 for burning the sample on the sample boat 201 that has been inserted from the sample placement unit 202. The sample boat 201 can be formed, for example, from ceramics; however, the present invention is not limited to this, so that the sample boat 201 can be formed from various other kinds of heat-resistant materials.

The sample placement unit 202 is provided with a cover 221 that can be opened and closed. In a state in which the cover 221 is opened, the sample boat 201 can be placed in the sample placement unit 202. The sample boat 201 placed in the sample placement unit 202 can be inserted into the combustion reaction unit 203 by moving a moving rod 222 disposed in the sample placement unit 202.

The combustion reaction unit 203 includes, for example, a tubular electric furnace 231 disposed in a lateral direction and a combustion tube 232 disposed in the electric furnace 231 and made of quartz glass. The sample boat 201 that is moved by the moving rod 222 from within the sample placement unit 202 is inserted into the combustion tube 232 in the combustion reaction unit 203. The temperature of the electric furnace 231 is set to be, for example, 900° C., and the sample on the sample boat 201 that has been inserted into the combustion tube 232 can be burnt.

The inside of the combustion tube 232 is filled with, for example, an oxidation catalyst 233. The total carbon component contained in the sample on the sample boat 201 that has been inserted into the combustion tube 232 is oxidized by action of the oxidation catalyst 233, and carbon dioxide is generated in an amount corresponding to the amount of the total carbon component contained in the sample. A carrier gas functioning also as a combustion-supporting gas is supplied into the sample placement unit 202. The carbon dioxide generated in the combustion tube 232 is conveyed, together with the carrier gas, to a cooling tube 204, cooled in the cooling tube 204, and thereafter conveyed to a drain separator 3.

The aforementioned inorganic carbon measurement device 1 is connected in series to the total carbon measurement device 2 via the drain separator 3. By this, the carrier gas supplied to the total carbon measurement device 2 can be supplied to the inorganic carbon measurement device 1 via the drain separator 3. In the inorganic carbon measurement device 1, the carrier gas conveyed from the total carbon measurement device 2 is supplied into the sample placement unit 102, and carbon dioxide generated in the reaction tube 132 can be conveyed to the drain separator 3 by the carrier gas.

A detection unit 4 for detecting carbon dioxide is connected to the drain separator 3. The detection unit 4 can be configured, for example, from an infrared carbon dioxide detector; however, the present invention is not limited to this. In measuring the inorganic carbon, the carbon dioxide generated by reaction of the sample in the reaction tube 132 in the inorganic carbon measurement device 1 is conveyed, together with the carrier gas, to the detection unit 4, and the carbon dioxide is detected by the detection unit 4, whereby the inorganic carbon contained in the sample can be measured. Meanwhile, in measuring the total carbon, the carbon dioxide generated by combustion of the sample in the combustion tube 232 in the total carbon measurement device 2 is conveyed, together with the carrier gas, to the detection unit 4, and the carbon dioxide is detected by the detection unit 4, whereby the total carbon contained in the sample can be measured.

For example, in performing cleanliness evaluation (cleaning validation) of a pharmaceutical facility or the like, a certain area of a surface of an object such as a pharmaceutical facility is wiped off with use of a swab material 5, whereby the substance (adherent residue) adhering to the surface of the object is physically collected. Referring to FIG. 1, the swab material 5 is mounted on the sample boat 201 together with the collected substance and placed in the sample placement unit 202 of the total carbon measurement device 2. Further, the sample boat 201 is moved by the moving rod 222, and the swab material 5 on the sample boat 201 is inserted into the combustion tube 232, whereby the substance collected into the swab material 5 as a sample is burnt in the combustion tube 232.

In using the swab material 5, the swab material 5 is thermally treated before the surface of the object is wiped off. In the thermal treatment, the swab material 5 is heated, for example, at a high temperature of about 450 to 600° C., whereby impurities such as an organic substance adhering to the swab material 5 are removed. The surface of the object is wiped off with the swab material 5 after the impurities on the swab material 5 are thus removed, so as to collect the substance, and the swab material 5 is burnt in the combustion tube 232 at a temperature (for example, 600° C. or higher) that is higher than that of the thermal treatment, whereby carbon dioxide can be generated from the collected substance.

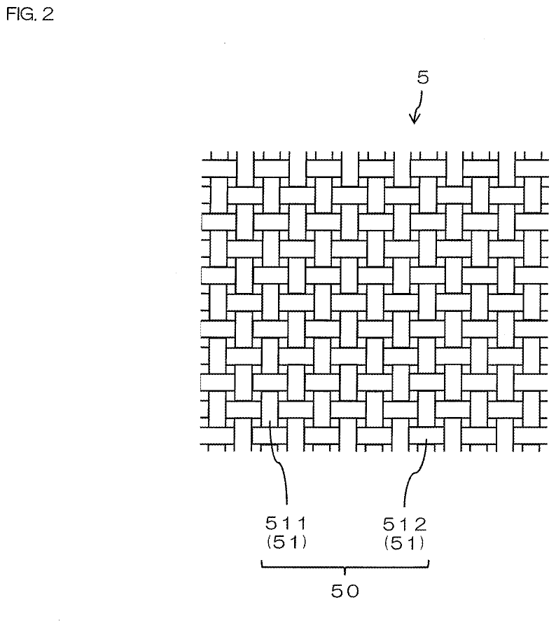

FIG. 2 is a schematic enlarged view showing a part of the swab material 5. The swab material 5 is made of a knitted body 50 in which numerous fibers 51 are knitted. Each fiber 51 is, for example, a heat-resistant glass fiber and is formed, for example, of a heat-resistant inorganic material such as a high silicate glass fiber. More specifically, each fiber 51 is formed of a high silicate glass fiber containing SiO₂ at 96% and having a heat resistance to ultrahigh temperature. This makes it possible to use each fiber 51 continuously at a high temperature of 1000° C. or more for a long period of time and is excellent in thermal durability, chemical stability, and electric insulation. The material of each fiber 51 is not particularly limited as long as the material is a heat-resistant inorganic material, and may be a material other than glass, such as ceramics; however, a material that is highly flexible and readily takes to water is preferred.

Each fiber 51 constitutes a warp thread 511 or a weft thread 512. In other words, the knitted body 50 is formed in such a manner that a plurality of warp threads 511 and a plurality of weft threads 512 are knitted perpendicularly to each other. The knitted body 50 may be formed by knitting individual fibers 51 or by bundling a plurality of fibers 51 and knitting the bundles with each other.

Thus, in the present embodiment, the swab material 5 is made of the knitted body 50, so that the tip ends of the fibers 51 constituting the knitted body 50 hardly protrude from the surface thereof, and the fibers 51 are not prone to coming apart from each other. Consequently, the surface of the object is hardly damaged when the substance is collected from the surface of the object, and high durability is obtained, as compared with a conventional swab material shaped to be a non-woven cloth.

Also, the fibers 51 constituting the knitted body 50 are made of a heat-resistant inorganic material, so that the swab material 5 can be thermally treated at a high temperature to remove the impurities that inherently adhere to the swab material 5 before wiping off the surface of the object, and carbon dioxide is not generated from the swab material 5 itself during the burning in the combustion tube 232. Accordingly, only the carbon dioxide generated from the substance that has been collected from the surface of the object can be detected, so that the detection accuracy can be improved.

In the present embodiment, the knitted body 50 has a melting point of 450° C. or higher. In other words, each fiber 51 constituting the knitted body 50 is formed of a material that does not melt at a temperature lower than 450° C. With such a configuration, the swab material 5 is not melted even when the swab material 5 is thermally treated before the surface of the object is wiped off, provided that the temperature is at least lower than 450° C. Accordingly, thermal treatments on the knitted body 50 can be effectively carried out, and the impurities that inherently adhere to the swab material 5 can be effectively removed.

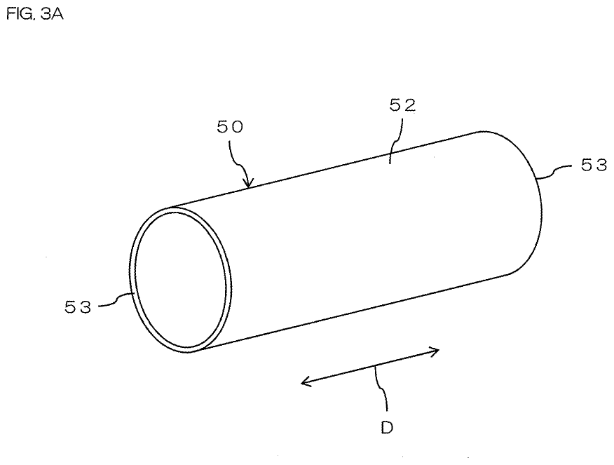

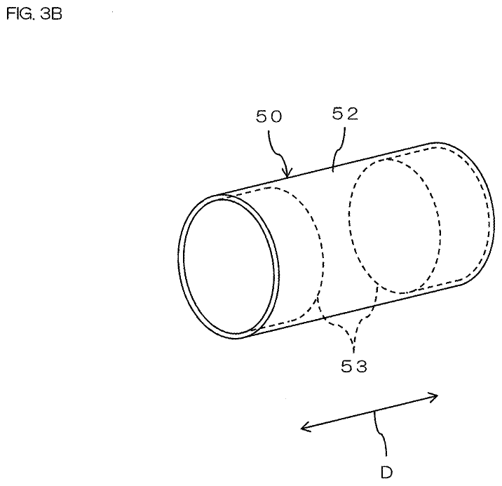

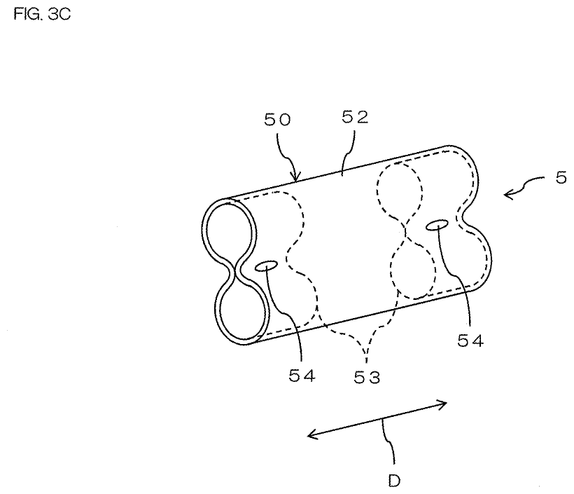

FIGS. 3A to 3C are each a schematic perspective view showing a flow in forming the swab material 5 from a knitted body 50. In this example, a swab material 5 such as shown in FIG. 3C is formed by using a knitted body 50 that has been formed to have a tubular shape by knitting each fiber 51 as shown in FIG. 3A.

As described by using FIG. 2, the knitted body 50 is formed by knitting a plurality of fibers 51. For this reason, in the tubular knitted body 50 shown in FIG. 3A, the tip ends of the fibers 51 hardly protrude from a circumferential surface 52 thereof; however, there are cases in which the tip ends of the fibers 51 are liable to protrude from end surfaces (cut surfaces) 53. Accordingly, in the present embodiment, the end surfaces 53 of the knitted body 50 are folded back.

Specifically, referring to FIG. 3B, the two end surfaces 53 of the tubular knitted body 50 are folded back to the inside of the circumferential surface 52 (within the knitted body 50). The knitted body 50 has an elongated shape along the axial direction D, and the two end surfaces 53 in the axial direction D are folded back so as to prevent the end surfaces 53 from being exposed to the outside. The tubular knitted body 50 shown in FIG. 3A has an inner diameter of about 8 mm, an outer diameter of about 9.5 mm, and a length in the axial direction D of about 30 mm, and is folded back at a position of about 5 mm from each of the two end surfaces 53.

In the knitted body 50 having the two end surfaces 53 folded back, part of the two ends is stitched, as shown in FIG. 3C. By this, a stopper 54 is formed at the two ends of the knitted body 50, and the knitted body 50 is maintained in a state in which the two end surfaces 53 of the knitted body 50 are folded back, so that the two end surfaces 53 are prevented from being exposed to the outside. The fiber used in stitching the two ends of the knitted body 50 may be, for example, the same as the fiber 51 constituting the knitted body 50.

The stopper 54 is fixed by approximating the circumferential surface 52 of the knitted body 50 in a radial direction. By this, the shape of the knitted body 50 as viewed in the axial direction D is like a figure of 8. In this example, one stopper 54 is provided at each of the two ends of the knitted body 50; however, the present invention is not limited to this, so that a plurality of stoppers 54 may be provided at each of the two ends.

In the present embodiment, the knitted body 50 has the end surface 53 folded back thereon, so that the tip ends of the fibers 51 constituting the knitted body 50 hardly protrude from the ends of the knitted body 50. Consequently, the surface of the object is hardly damaged in collecting the substance from the surface of the object.

Also, when the swab material 5 is formed by using the tubular knitted body 50, a gripping tool such as a pair of tweezers can be readily inserted into the swab material 5 from the ends, thereby facilitating handling of the swab material 5. In this case, the configuration of the tubular knitted body 50 is not limited to one in which the stopper 54 is formed at the ends of the tubular knitted body 50 as shown in FIG. 3C, but may be one in which the stopper 54 is not formed. Further, when the swab material 5 is formed by using the tubular knitted body 50, the sites of the end surfaces of the knitted body 50 can be reduced, thereby producing an effect that the tip ends of the fibers 51 constituting the knitted body 50 are further less likely to protrude from the surface.

However, the shape of the swab material 5 is not limited to a tubular shape, so that the swab material 5 may be configured from a knitted body 50 having a different shape such as a band shape, a rope shape (for example, a braid shape), or a web shape. In other words, the knitted bodies in which fibers are knitted encompass knitted bodies in which fibers are knitted by any of the knitting methods such that the fibers are formed into one shape by being alternately combined with each other irrespective of the knitting methods. In this case, the swab material 5 may be formed by folding back the end surfaces of the knitted bodies 50. Here, the knitted body 50 may have a configuration in which the end surfaces of the knitted body 50 are not folded back but the fibers 51 are knitted so that the tip ends of the fibers 51 may not protrude from the end surfaces of the knitted body 50.

In the above-described embodiment, a case has been described in which the swab material 5 with which the surface of the object has been wiped off is inserted into the combustion tube 232 provided in the total carbon measurement device 2 of the total organic carbon measurement device. However, the swab material 5 according to the present invention can be used by being inserted into the combustion tube 232 provided in the total carbon measurement device 2 even when only the total carbon measurement device 2 is separately configured or when the total carbon measurement device 2 is integrally configured with devices other than the inorganic carbon measurement device 1.

Here, a swab material can be provided in which a plurality of fibers are placed by being arranged in parallel and the ends thereof are fixed to each other by being bound or the like. In this case, the plurality of fibers may be placed in a planar shape. In this manner, when the ends of the plurality of fibers are fixed to each other and bundled, it is possible to avoid a situation in which the fibers themselves are scattered around in an environment where experiments are carried out.

### DESCRIPTION OF REFERENCE SIGNS

1 inorganic carbon measurement device
2 total carbon measurement device
3 drain separator
4 detection unit
5 swab material
50 knitted body
51 fibers
52 circumferential surface
53 end surface
54 stopper
201 sample boat
202 sample placement unit
203 combustion reaction unit
204 cooling tube
232 combustion tube
511 warp thread
512 weft thread

1. A swab material used for wiping off a surface of an object to collect a substance existing thereon, the swab material being inserted together with the collected substance into a combustion tube provided in a total carbon measurement device, the swab material comprising a knitted body in which fibers made of a heat-resistant inorganic material are knitted,
wherein the knitted body has an end surface folded back thereon.

2. The swab material according to claim 1, wherein the knitted body has a melting point of 450° C. or higher.

3. (canceled)
